(19) United States
(12) Patent Application Publication
(10) Pub. No.: US 2025/0337975 A1
(43) Pub. Date: Oct. 30, 2025

(54) METHOD AND SYSTEM FOR MANAGING MULTIPLE EXTERNAL REPEATERS

(71) Applicant: HYBE Co., Ltd., Seoul (KR)

(72) Inventors: Bo Yoon CHOI, Seoul (KR); Sung Joo JEONG, Seoul (KR)

(73) Assignee: HYBE Co., Ltd., Seoul (KR)

(21) Appl. No.: 19/188,884

(22) Filed: Apr. 24, 2025

(30) Foreign Application Priority Data
Apr. 24, 2024 (KR) 10-2024-0054881

(51) Int. Cl. H04N 21/43

(52) U.S. Cl. CPC H04N 21/43076; H04N 21/43079

(57) ABSTRACT

A method for managing multiple external repeaters in a repeater management application of a terminal includes connecting to a service providing server to be linked to the multiple external repeaters located at multiple streaming spots; acquiring a request to transmit a lighting-direction control signal from each of the linked multiple external repeaters; controlling to transmit the lighting-direction control signal matched with each of the multiple external repeaters according to the acquired request; acquiring and displaying repeater status information for the multiple external repeaters through a repeater management interface; and determining a first repeater of the multiple external repeaters based on the acquired repeater status information and remotely controlling the first repeater.

### CROSS-REFERENCE TO RELATED APPLICATION

This application claims priority to and benefits of Korean Patent Application No. 10-2024-0054881 filed on Apr. 24, 2024, in the Korean Intellectual Property Office under 35 U.S.C. § 119, the entire contents of which are incorporated herein by reference.

### BACKGROUND

### 1. Technical Field

The disclosure relates to a method and system for managing multiple external repeaters capable of managing the multiple external repeaters transmitting a control signal to multiple light emitting devices located at a separate place from the actual auditorium.

### 2. Description of Related Art

Light emitting devices display various colors and generate various effects in a dark space, and are utilized as cheering tools at concerts and showcases during nighttime activities and events such as sports events, festivals, and parades.

Light emitting devices have evolved beyond simple cheering tools. A manager control light emitting devices that people have, such as the light emitting devices being combined to create specific letters and shapes. Thus, various direction may be enabled at an event.

However, these light emitting devices are still only utilized for directing audiences in concert halls. In situations in which the venue changes or the audience size is smaller than expected, their use becomes difficult due to limitations in transmission range, venue constraints, and the absence of dedicated operators.

Furthermore, even in a situation in which complex performance directing is unnecessary, at least one operator is required to be present at an external location (e.g., a designated streaming site spaced apart from an actual auditorium) to handle directing, resulting in inefficient use of human resources.

Therefore, discussions are underway to expand the scope of light emitting devices and to improve a current system including an operator to be dispatched to an external location to which a remote concert is being transmitted.

It is to be understood that this background of the technology section is, in part, intended to provide useful background for understanding the technology. However, this background of the technology section may also include ideas, concepts, or recognitions that were not part of what was appreciated by those skilled in the pertinent art prior to a corresponding effective filing date of the subject matter disclosed herein.

### SUMMARY

Embodiments provide a method and system capable of managing multiple external repeaters, which remotely control the multiple external repeaters, and the multiple external repeaters transmit a control signal for causing multiple light emitting devices located at a streaming spot, which is a separate place from an actual auditorium, to emit light in the same emission pattern as an emission pattern directed at an actual auditorium.

Embodiments also provide a method and system capable of managing multiple external repeaters, which check a status of multiple repeaters installed at streaming spots, which are separate places from an actual auditorium, in real time and remotely control the multiple repeaters as needed.

Embodiments also provide a method and system capable of managing multiple external repeaters, which allow a staff of a streaming spot, which is a separate place from an actual auditorium, to install repeaters on his/her own without dispatching an operator to the streaming spot, which is the separate place from the actual auditorium.

However, embodiments of the disclosure are not limited to those set forth herein. The above and other embodiments will become more apparent to one of ordinary skill in the art to which the disclosure pertains by referencing the detailed description of the disclosure given below.

A method for managing multiple external repeaters according to an aspect of the disclosure is a method for managing multiple external repeaters in a repeater management application of a terminal, the method including: linking to the multiple external repeaters, which are electrically connected to a service providing server and located at multiple streaming spots; acquiring a request to transmit a lighting-direction control signal from each of the linked multiple external repeaters; controlling to transmit the lighting-direction control signal matched with each of the multiple external repeaters according to the acquired request; acquiring and displaying repeater status information for the multiple external repeaters through a repeater management interface; and determining a first repeater of the multiple external repeaters based on the acquired repeater status information and remotely controlling the first repeater.

The linking to the multiple external repeaters may include at least one of acquiring a streaming video from the service providing server and controlling the first repeater placed in a first streaming spot of the multiple streaming spots to transmit a playback signal of the acquired streaming video; and controlling the first repeater placed in the first streaming spot to acquire the playback signal of the streaming video transmitted from an external terminal or server placed in the first streaming spot.

The acquiring of the request to transmit the lighting-direction control signal may include detecting a first streaming video being played by the first repeater requesting to transmit the lighting-direction control signal; and extracting first lighting-direction synchronization data matched with the detected first streaming video.

The extracting of the first lighting-direction synchronization data may include determining that a type of the first streaming video is one of a real-time video and a recorded video; and extracting at least one of the first lighting-direction synchronization data being transmitted in real time from an actual auditorium and second lighting-direction synchronization data pre-stored in the service providing server according to the determined video type.

The controlling of transmitting the lighting-direction control signal may include determining at least one of basic direction data and seat-specific direction data; and controlling to transmit the lighting-direction control signal including command data that activates light emission in accordance with the determined direction data. At least one of emission time, brightness, color, and effect of the light emitting devices within a predetermined radius by default may be set in the basic direction data according to a performance configuration. The seat-specific direction data being generated by setting the at least one of emission time, brightness, color, and effect of the light emitting devices within a predetermined radius of the basic direction data differently for each seat.

The acquiring and displaying of the repeater status information through the repeater management interface may include acquiring and displaying the repeater status information including at least one of a repeater power supply state, a repeater location, a repeater Internet connection state, a repeater operation state, and the number of light emitting devices electrically connected to the repeater.

The acquiring and displaying of the repeater status information through the repeater management interface may include displaying a degree of progress of a performance being held at the actual auditorium and a lighting-direction control signal being transmitted in the performance, and a degree of progress of a streaming performance being transmitted from each of the multiple repeaters and a lighting-direction control signal being transmitted in the streaming performance.

The determining and remotely controlling the first repeater based on the acquired the repeater status information may include determining the first repeater whose streaming time point deviates from a performance progress time point by more than a tolerance range; and remotely controlling at least one of a power supply, an Internet connection state, and synchronization between a video and a control signal for the determined first repeater.

The remotely controlling of the synchronization between the video and the control signal may include receiving a current playback time point of the streaming video played by the first repeater; determining a lighting-direction block at a first future time point which is later than the received current playback time point; determining whether the current playback time point and the first future time point match; and remotely controlling the lighting-direction control signal to play the lighting-direction block at the determined first future time point when the current playback time point and the first future time point match.

A system for managing multiple external repeaters according to an aspect of the disclosure is linked to a service providing server and the multiple external repeaters electrically connected the service providing server, wherein at least one application stored in a memory of a terminal, which includes at least one memory and at least one processor, and executed by the processor to provide a repeater management service. The at least one application performs acquiring a request to transmit a lighting-direction control signal from each of the multiple external repeaters; controlling to transmit the lighting-direction control signal matched with each of the multiple external repeaters according to the acquired request; acquiring and displaying repeater status information for the multiple external repeaters through a repeater management interface; and determining a first repeater of the multiple external repeaters based on the acquired repeater status information and remotely controlling the first repeater.

### BRIEF DESCRIPTION OF THE DRAWINGS

The above and other aspects, features, and advantages of certain embodiments will be more apparent from the following description taken in conjunction with the accompanying drawings, in which:

FIG. 1 is a schematic diagram of a repeater management service providing system according to an embodiment of the disclosure;

FIG. 2 is a schematic internal block diagram of a terminal according to an embodiment of the disclosure;

FIG. 3 is a schematic internal block diagram of a repeater according to an embodiment of the disclosure;

FIG. 4 is a schematic flowchart illustrating a method for managing multiple external repeaters according to an embodiment of the disclosure;

FIGS. 5 and 6 are schematic diagrams of a repeater management interface according to an embodiment of the disclosure;

FIG. 7 is a schematic flowchart illustrating a synchronization process between a streaming video and a streaming spot control signal according to an embodiment of the disclosure; and

FIG. 8 is a schematic diagram illustrating a synchronization process according to an embodiment of the disclosure.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the disclosure. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the disclosure.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the axis of the first direction DR1, the axis of the second direction DR2, and the axis of the third direction DR3 are not limited to three axes of a rectangular coordinate system, such as the X, Y, and Z-axes, and may be interpreted in a broader sense. For example, the axis of the first direction DR1, the axis of the second direction DR2, and the axis of the third direction DR3 may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the disclosure. Further, the blocks, units, and/or modules of some embodiments may be physically combined into more complex blocks, units, and/or modules without departing from the scope of the disclosure.

The terms “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

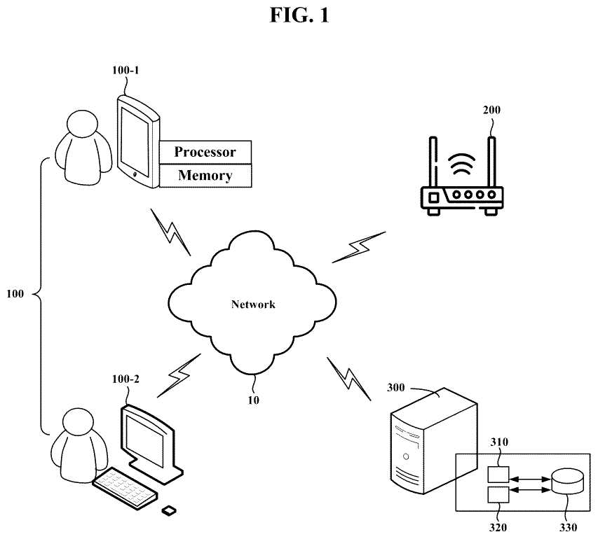

FIG. 1 is a schematic diagram of a repeater management service providing system according to an embodiment of the disclosure.

Referring to FIG. 1, the repeater management service providing system (hereinafter, “service providing system”) according to the embodiment of the disclosure may provide a repeater management service for managing multiple external repeaters that transmits a control signal to multiple light emitting devices located (or disposed) at a streaming spot (e.g., a predetermined or selectable streaming spot). The streaming spot may be a separate place from the actual auditorium. Thus, the multiple external repeaters may transmit, to the multiple light emitting devices, a control signal for causing the light emitting devices to emit light in the same emission pattern as an emission pattern directed at an actual auditorium (hereinafter, “repeater management service”). For example, the light emitting devices may receive the control signal from the multiple external repeaters, and emit the same illumination pattern as the actual auditorium.

In an embodiment, the streaming spot may be a type of an outdoor theater where a number (e.g., a predetermined or selectable number) of people gather to stream (or view) a performance video obtained by filming a performance that is held in real time or with pre-recording at the actual auditorium.

In the embodiment, each of the light emitting devices may be a device (e.g., a predetermined or selectable device) that emits light according to a control signal including emission pattern setting values such as brightness, saturation, and effect received from the repeater through the repeater management service.

According to an embodiment, data for causing the multiple light emitting devices to emit light with the same emission pattern as an emission pattern directed in the actual auditorium may be referred to as “lighting-direction synchronization data”. For example, the light-direction synchronization data may illuminate the multiple light emitting devices with the same emission pattern as the emission pattern of the actual auditorium. A control signal for activating the lighting-direction synchronization data may be referred to as a “lighting-direction control signal”.

In the embodiment, the service providing system implementing (or performing) the above-described repeater management service may be electrically connected via a terminal 100, a repeater 200, a service providing server 300, and a network 10.

The network 10 according to the embodiment may have a connection structure that enables information exchange between respective nodes, such as the terminal 100, the repeater 200, and/or the service providing server 300. Examples of the network 10 may include a 3rd generation partnership project network (3GPP), a long term evolution (LTE) network, a world interoperability for microwave access network (WIMAX), the Internet, a local area network (LAN), a wireless local area network (wireless LAN), a wide area network (WAN), a personal area network (PAN), a Bluetooth network, a satellite broadcasting network, an analog broadcasting network, a digital multimedia broadcasting (DMB) network, and the like. However, the disclosure is not limited thereto.

The terminal 100, the repeater 200, and/or the service providing server 300 may implement the service providing system, and detailed description of the service providing system is provided below.

### Terminal 100

The terminal 100 according to the embodiment of the disclosure may be a computing device (e.g., a predetermined or selectable computing device) on which the repeater management application 111 (hereinafter, application) providing a repeater management service is installed.

The application 111 providing the repeater management service may be installed in the terminal 100, a user of the terminal 100 may be a repeater management service manager. The repeater management service manager may be a person who manages the overall repeater management service for ascertaining (or determining) a status of multiple repeaters installed at multiple streaming spots and remotely controlling the repeaters, and may be different from a staff of the streaming spot who appears hereinafter. For example, the overall repeater management service may include determining the status of the multiple repeaters of the multiple streaming spots and remotely controlling the repeaters, and the terminal 100 may perform the overall repeater management service.

For example, the terminal 100 may include a mobile computing device 100-1 and/or a desktop computing device 100-2 in which the repeater management application 111 is installed. However, the disclosure is not limited thereto.

The mobile computing device 100-1 may be a mobile device such as a smart phone or a tablet PC in which an application including the repeater management application 111 is installed.

For example, the mobile computing device 100-1 may include a smart phone, a mobile phone, a digital broadcasting device, a personal digital assistant (PDA), a portable multimedia player (PMP), a tablet PC, or the like.

For example, the desktop computing device 100-2 may include a device in which a program for executing a repeater management service based on wired/wireless communication is installed. For example, the desktop computing device 100-2 may include a personal computer, a fixed desktop PC, a laptop computer, or an ultrabook in which the repeater management application 111 is installed.

According to an embodiment, the terminal 100 may further include a server computing device (e.g., a predetermined or selectable server computing device) that provides a repeater management service environment.

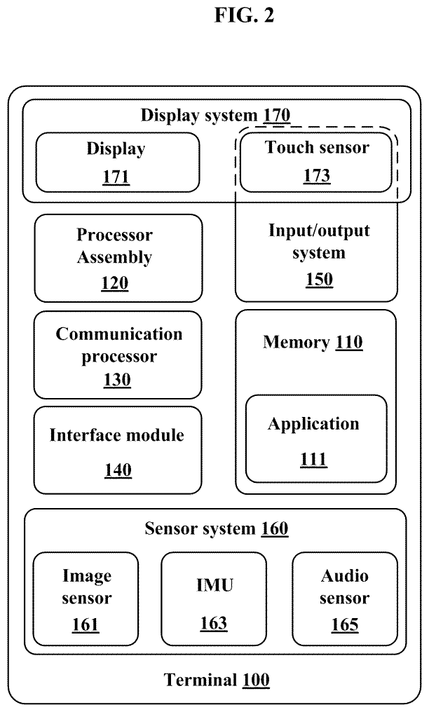

FIG. 2 is a schematic internal block diagram of the terminal according to an embodiment of the disclosure.

Referring to FIG. 2, detailed description of a function or an operation of the terminal 100 is described. For example, the terminal 100 may include the memory 110, a processor assembly 120, a communication processor 130, an interface module 140, an input and output system 150, a sensor system 160, and a display system 170. For example, the memory 110, the processor assembly 120, the communication processor 130, the interface module 140, the input and output system 150, the sensor system 160, and the display system 170 may be included (or disposed) in a housing of the terminal 100.

For example, the repeater management application 111 may be stored in the memory 110 and may store one or more of various application programs, data, and instructions for providing the repeater management service environment.

For example, the memory 110 may store instructions and data that may be used to create the repeater management service environment.

The memory 110 may include a program area and a data area.

The program area according to the embodiment may be linked between an operating system (OS) that boots the terminal 100 and functional elements, and the data area may store data generated as the terminal 100 is used (e.g., various data generated in the terminal 100).

The memory 110 may include at least one non-transitory computer-readable storage medium, and a temporary computer-readable storage medium.

For example, the memory 110 may be any of various storage devices such as a ROM, an EPROM, a flash drive, and a hard drive, and may include a web storage that performs a storage function of the memory 110 on the Internet.

The processor assembly 120 may include at least one processor that executes the instructions of the repeater management application 111 stored in the memory 110, and the processor may perform various tasks for creating the repeater management service environment.

In an embodiment, the processor assembly 120 may control an overall operation of the components through the repeater management application 111 of the memory 110 and provide the repeater management service.

The processor assembly 120 may be a system on chip (SOC) suitable for the terminal 100. For example, the processor assembly 120 may include a central processing unit (CPU) and/or a graphic processing unit (GPU), and may execute the operating system (OS) and/or application program stored in the memory 110 and control each component mounted on the terminal 100.

The processor assembly 120 may communicate with each component internally via a system bus, and may include one or more bus structures (e.g., predetermined or selectable bus structures) including a local bus.

The processor assembly 120 may include at least one of application specific integrated circuits (ASICs), digital signal processors (DSPs), digital signal processing devices (DSPDs), programmable logic devices (PLDs), field programmable gate arrays (FPGAs), controllers, micro-controllers, and microprocessors. However, the disclosure is not limited thereto, and the processor assembly 120 may include other electrical units for performing functions.

The communication processor 130 may include one or more devices for communication with external devices. The communication processor 130 may perform communication via a wireless network.

For example, the communication processor 130 may communicate with other components of the terminal 100 that stores a content source for implementing the repeater management service environment, and may communicate with various user input components such as a controller that receives user input.

In an embodiment, the communication processor 130 may transmit or receive various types of data related to the repeater management service to or from another terminal 100 and/or an external server.

The communication processor 130 may wirelessly transmit or receive data to or from at least one of a base station, an external terminal, and an arbitrary server on a mobile communication network constructed through a communication device capable of performing technical standards or communication schemes (e.g., long term evolution (LTE), long term evolution-advanced (LTE-A), 5G New Radio (NR), and WIFI) for mobile communication, a short-range communication scheme, or the like. For example, the communication processor 130 may wirelessly communicate with the at least one of the base station, the external terminal, and the arbitrary server through various communication methods.

The interface module 140 may communicatively (or electrically) connect the terminal 100 to one or more other devices. For example, the interface module 140 may include a wired and/or wireless communication device that is compatible with one or more different communication protocols.

Through the interface module 140, the terminal 100 may be electrically connected to various input and output devices.

For example, the interface module 140 may be electrically connected to an audio output device such as a headset port or a speaker and output audio.

For example, the audio output device may be electrically connected through the interface module 140. However, the disclosure is not limited thereto. In an embodiment, the audio output device may be installed inside the terminal 100.

For example, the interface module 140 may be electrically connected to an input device such as a keyboard and/or a mouse and acquire user input.

The interface module 140 may include at least one of a wired/wireless headset port, an external charger port, a wired/wireless data port, a memory card port, a port for connecting a device including an identification module, an audio input/output (I/O) port, a video input/output (I/O) port, an earphone port, a power amplifier, an RF circuit, a transceiver, or the like. However, the disclosure is not limited thereto, and the interface module 140 may include other communication circuits.

The input and output system 150 may detect a user's input related to the repeater management service (e.g., a gesture, a voice instruction, an operation of a button, or another type of input).

The input and output system 150 may include a sensor system 160 and a display system 170.

For example, the input and output system 150 may include a button (e.g., a predetermined or selectable button), a touch sensor, and/or an image sensor that receives a user motion input.

The input and output system 150 may be electrically connected to an external controller through the interface module 140 and receive a user input.

The input and output system 150 may receive a user input (e.g., a touch input, a mouse input, a keyboard input, a gesture input, and a motion input using a guide tool).

For example, the terminal 100 may be electrically connected to at least one device, such as a mouse 151, a keyboard 153, a gesture input controller, an image sensor (e.g., a camera), or an audio sensor via the input and output system 150 according to various communication protocols, and acquire a user input.

The terminal 100 may be electrically connected to an external output device via the input and output system 150. For example, the terminal 100 may be electrically connected to a display system 170, an audio output device, or the like and output data (e.g., predetermined or selectable data).

The sensor system 160 may include various sensors such as an image sensor 161, a location sensor (IMU) 163, an audio sensor 165, a distance sensor, a proximity sensor, and a contact sensor. However, the disclosure is not limited thereto.

The image sensor 161 may capture an image and/or video of a physical space around the terminal 100.

In an embodiment, the image sensor 161 may capture and acquire various images and/or videos related to the repeater management service.

The image sensor 161 may be disposed on the front surface or/and rear surface of the terminal 100 and capture a video in a direction in which the image sensor 161 is disposed. For example, the image sensor 161 may film a physical space through a camera facing the outside of the terminal 100.

The image sensor 161 may include an image sensor device and a video processing module. For example, the image sensor 161 may process still images or moving images obtained by the image sensor device (e.g., a CMOS or CCD).

The image sensor 161 may process the still images or moving images obtained by the image sensor device using an image recognition process (e.g., OCR) and/or the video processing module to extract necessary information and transfer the extracted information to the processor.

The image sensor 161 may be a camera assembly including at least one camera. The camera assembly may include a general camera that films a visible light band, and may further include a special camera such as an infrared camera or a stereo camera.

The image sensor 161 as described above may be disposed (e.g., included and operated) in the terminal 100 according to an embodiment. In other embodiments, the image sensor 161 may be included in an external device (e.g., an external server) and operated through linkage based on the communication processor 130 and/or the interface module 140 described above.

The audio sensor 165 may recognize sounds around the terminal 100.

For example, the audio sensor 165 may include a microphone capable of detecting a voice input of a user using the terminal 100.

In an embodiment, the audio sensor 165 may receive voice data required for the repeater management service from the user.

The display system 170 may output various types of information related to the repeater management service as graphic images.

In an embodiment, the display system 170 may display various user interfaces for a repeater management service (e.g., a repeater management interface).

The display system 170 may include at least one of a liquid crystal display (LCD), a thin film transistor-liquid crystal display (TFT LCD), an organic light emitting diode (OLED), a flexible display, a 3D display, and an e-ink display. However, the disclosure is not limited thereto.

The above components (e.g., the display system 170) may be disposed inside the housing of the terminal 100, and the user interface may include a touch sensor 173 on a display 171 configured to receive a user touch input.

For example, the display system 170 may include the display 171 that outputs an image and the touch sensor 173 that detects a user's touch input.

For example, the display 171 may be implemented as a touch screen by forming a mutual layer structure with the touch sensor 173. For example, the display 171 and the touch sensor 173 may form a double-layer structure. In other embodiments, the display 171 and the touch sensor 173 may be integral with each other. The touch screen (e.g., the display system 170) may function as a user input part that provides an input interface between the terminal 100 and the user, and may provide an output interface between the terminal 100 and the user.

The terminal 100 including the above-described components may store at least one streaming video, lighting-direction synchronization data, lighting-direction control signal, basic direction data, seat-specific direction data, repeater status information, and/or repeater setting information in the memory 110 according to an embodiment.

Although the terminal 100 according to the embodiment of the disclosure performs the functional operation as described above, various other embodiments are possible. For example, at least a part of the functional operation performed by the terminal 100 may be performed by an external device (e.g., the service providing server 300 of FIG. 1) according to the embodiment, and at least a part of a functional operation performed by the external device may be further performed by the terminal 100, the repeater 200 (e.g., refer to FIG. 1), and/or the service providing server 300.

### Repeater 200

The repeater 200 according to the embodiment of the disclosure may be a computing device that receives the lighting-direction synchronization data from the service providing server 300 under the control of the repeater management application 111 that provides a repeater management service, and transmits a control signal including the received lighting-direction synchronization data. For example, the repeater 200 may receive the lighting-direction synchronization data from the service providing server 300, and transmit the control signal including the received light-direction synchronization data. The repeater 200 may control the multiple light emitting devices located (or disposed) within a distance (e.g., a predetermined or selectable distance).

For example, in the embodiment, the repeater 200 may communicate with the terminal 100 and/or the service providing server 300 through a wired or wireless network and acquire at least one piece of lighting-direction synchronization data. The repeater 200 may transmit a control signal for activating the light emitting device to emit light with the acquired lighting-direction synchronization data.

In an embodiment, the repeater 200 may be a device that is installed in advance at a streaming spot (e.g., a predetermined or selectable streaming spot), which is a separate place from the actual auditorium where the performance is streamed, to transmit a control signal (e.g., a predetermined or selectable control signal) to at least one light emitting device detected within a range (e.g., a preset or selectable range).

In an embodiment, the repeater 200 may include a repeater terminal and/or an antenna.

The repeater terminal and the antenna may be in a 1:1 and/or 1:n relationship. The antenna may be a directional antenna.

The repeater terminal may be installed in an indoor space, and the antenna may be installed in an outdoor space. For example, the repeater terminal may be installed on a wall or ceiling of the indoor space, and the antenna may be installed on an external wall of a building and a railing in the outdoor space.

For example, the repeater terminal may include an LCD display. The LCD display may display information (e.g., predetermined or selectable information) downloaded for provision of the repeater management service. However, the disclosure is not limited thereto, and the repeater terminal may include various displays.

The repeater 200 may readily control a large number of light emitting devices without individual pairing since the repeater 200 may transmit the control signal without having to individually detect locations of light emitting devices by being simply installed in a place (e.g., a predetermined or selectable place). Thus, the repeater 200 may be readily installed without location detection of the light emitting devices.

In the embodiment, the repeater 200 may transmit a control signal (e.g., a predetermined or selectable control signal) to at least one light emitting device detected within a range (e.g., a preset or selectable range) according to setting information.

In the embodiment, the setting information may include a signal radius and/or a propagation direction. The setting information may be preset by the repeater management service manager (hereinafter, “manager”), and detailed description of the setting information is provided below.

The terminal 100 and/or the repeater 200 may generate and set the setting information to be applied to the repeater 200.

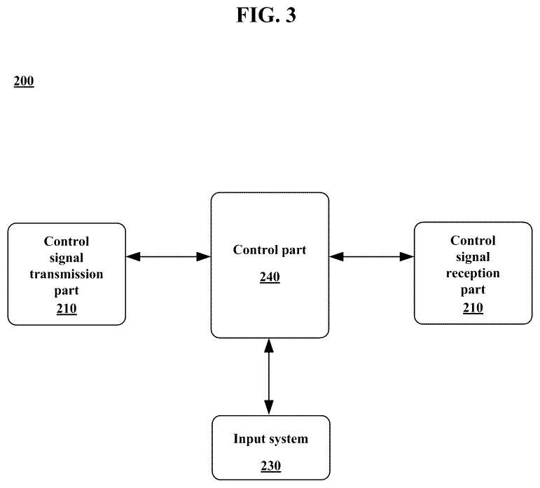

FIG. 3 is a schematic internal block diagram of a repeater according to an embodiment of the disclosure.

Referring to FIG. 3, the repeater 200 may include a control signal transmission part 210, a control signal reception part 220, an input system 230, and a control part 240. For example, the control signal transmission part 210, the control signal reception part 220, the input system 230, and the control part 240 be included (or disposed) in a housing of the repeater 200.

For example, the control signal transmission part 210 may include one or more devices for performing communication with the terminal 100.

The control signal transmission part 210 may perform communication with other terminals and implement (or form) an environment for control signal communication.

In the embodiment, the control signal transmission part 210 may transmit or receive various types of data related to the control signal communication to and from other terminals and/or external servers. However, the disclosure is not limited thereto.

The control signal transmission part 210 may wirelessly transmit or receive data to or from at least one of a base station, an external terminal, an arbitrary server, and antenna on a mobile communication network constructed through a communication device capable of performing technical standards or communication schemes (e.g., long term evolution (LTE), long term evolution-advanced (LTE-A), 5G New Radio (NR), and WIFI) for mobile communication, a short-range communication scheme (e.g., NFC or RFID), a wireless communication scheme (RF or IR), and/or the like. For example, the control signal transmission part 210 may wirelessly communicate with the at least one of the base station, the external terminal, and the arbitrary server through various communication methods.

In the embodiment, the control signal transmission part 210 may transmit information based on a short-range communication scheme.

In the embodiment, the control signal transmission part 210 may include a wireless communication module for short-range communication (e.g., at least one of NFC, RF transmitter/receiver, Zigbee, Bluetooth, and WiFi modules).

In the embodiment, the control signal transmission part 210 may transmit a control signal received from the terminal 100 to at least one other device (in the embodiment, a light emitting device) in a one-to-many manner. For example, the control signal transmission part 210 may transmit the control signal to multiple devices.

For example, the control signal transmission part 210 may transmit a control signal to at least one light emitting device in a broadcasting manner (an all-to-all communication scheme for transferring traffic to an unspecified number of people without designating a recipient).

For example, the control signal transmission part 210 may transmit a control signal to the nearby light emitting devices according to a broadcasting protocol (e.g., a preset or selectable broadcasting protocol). The light emitting devices located (or disposed) in a short range set to receive a broadcast signal of the broadcasting protocol may receive the transmitted control signal, and operate according to the received control signal.

For example, the broadcasting protocol may be a frequency band and a control signal encoding/decoding scheme. The control signal transmission part 210 may include a broadcast transmitter. The broadcasting transmitter may include an exciter configured of an oscillator and a modulator. The broadcasting transmitter may modulate the control signal received from the terminal 100 with radio waves in a frequency band determined according to the broadcasting protocol, and transmit an RF signal through an antenna.

The control signal transmission part 210 may use a broadcasting scheme, and solve problems of low transmission speed, short transmission distance, small data capacity transmission, excessive power consumption, and the like, which are disadvantages of Bluetooth (BLE) technology. For example, the control signal transmission part 210 may have various abilities of facilitating control of multiple light emitting devices, reducing time required for pairing that a user should perform separately for each light emitting device with the light emitting device control signal repeater 200, and increasing a data transmission rate.

In the embodiment, the control signal transmission part 210 may continuously transmit (e.g., infinitely loop) a control signal for activating a directing data (e.g., a predetermined or selectable directing data) when an event (e.g., a predetermined or specific event) and/or trigger is acquired. For example, the event and/or trigger may include detection of a person's approach based on a sensor (e.g., a predetermined or selectable sensor), detection of an input to a light emitting device, a time period (e.g., a preset or selectable cycling cycle), and the like.

The control signal reception part 220 may receive a control signal from another terminal including the terminal 100 and/or a server.

The control signal reception part 220 may include one or more devices for communicating with the terminal 100, similar to the control signal transmission part 210, and detailed description of the same or similar constituent elements is omitted.

The input system 230 may detect a user's input (e.g., a gesture, a voice instruction, an operation of a button, or another type of input) related to the repeater management service. For example, the input system 230 may include a button (e.g., a predetermined or selectable button), a controller, a touch sensor, and/or an image sensor that receives a user motion input.

The input system 230 may be electrically connected to an external controller through an interface part and receive a user's input.

The input system 230 may receive a user's input (e.g., a touch input, a mouse input, a keyboard input, a gesture input, or a motion input using a guide tool).

For example, the repeater 200 may be electrically connected to at least one device of a numeric keypad and an IR remote control according to various communication protocols via the input system 230 by a cable and/or wirelessly and acquire the user input.

The repeater 200 may include an interface part (e.g., a USB connection port) and acquire the user input through a wired connection.

For example, a type of input to the input system 230 of the repeater 200 may include an input according to a direct manipulation, a wired input, and/or a wireless input.

For example, the input may be performed based on a series of wired and wireless input devices (e.g., a keyboard, a numeric keypad, a mouse, and a remote control) electrically connected to a USB connection port of the repeater 200.

In the wired input, remote control may be performed using the cable. The wireless input may be performed through a remote control linked to IR, RF, NFC, Bluetooth and/or the repeater 200. There should be no obstacles in front of an IR sensor of the repeater 200 and/or remote control.

The control part 240 may include at least one processor capable of executing instructions for transmitting or receiving at least one control signal, and perform various tasks for creating a repeater management service environment.

In the embodiment, the repeater 200 may include at least one location sensor (e.g., GPS). Accordingly, the control part 240 may provide location information of the repeater acquired by the location sensor to the linked terminal 100 and/or service providing server 300.

In the embodiment, the repeater 200 may include at least one image sensor (e.g., camera). Accordingly, the control part 240 may provide an image and/or video of a physical space around the repeater 200 to the linked terminal 100 and/or service providing server 300.

In the embodiment, the control part 240 may control an overall operation of the components of the repeater 200 and provide the repeater management service. In the control part 240, the above description (e.g., the operation) may be applied in the processor assembly 120 of the terminal 100. Thus, detailed description of the same or similar constituent elements is omitted.

### Service Providing Server 300

The service providing server 300 (e.g., refer to FIG. 1) according to the embodiment of the disclosure may perform a series of processes for providing the repeater management service.

In the embodiment, the service providing server 300 may be a central management device that controls the terminal 100 and/or the repeater 200, and may be implemented as a computing device (e.g., a predetermined or selectable computing device).

For example, in the embodiment, the service providing server 300 may provide the repeater management service by exchanging data necessary for a repeater management process to be driven in an external device such as the terminal 100 and/or the repeater 200 with the external device. For example, the service providing server 300 may exchange the data for the repeater management process with the external device, and the repeater management process may be provided.

For example, in the embodiment, the service providing server 300 may provide an environment in which multiple applications installed in multiple devices performing the repeater management service may operate in the external device.

The service providing server 300 may include application programs, data, and/or instructions for operation of applications, and may transmit or receive data based on these (e.g., the application programs, the data, and/or the instructions for the operation of the applications) to and from the external device.

For example, the service providing server 300 may provide the repeater management service based on a repeater management program for providing the repeater management service.

In the embodiment, the service providing server 300 may be linked to at least one terminal 100 and/or repeater 200, and control the linked terminal 100 and/or repeater 200 in an integrated manner.

In the embodiment, the service providing server 300 may transmit lighting-direction synchronization data (e.g., predetermined or selectable lighting-direction synchronization data) to the linked terminal 100 and/or repeater 200.

In the embodiment, the service providing server 300 may acquire repeater setting information from the linked terminal 100 and/or repeater 200.

In the embodiment, the service providing server 300 may store and manage various application programs, instructions, and/or data for implementing the repeater management service.

Referring to FIG. 1, in the embodiment, the service providing server 300 as described above may be implemented as a computing device (e.g., a predetermined or selectable computing device) including at least one processor module 310 for data processing, at least one communication module 320 for data exchange with an external device, and at least one memory module 330 for storing various application programs, data, and/or instructions for providing the repeater management service.

The database 330 may store any one or more of an operating system (OS), various application programs, data, and instructions for providing the repeater management service. The database 330 may include a program area and a data area.

The program area according to the embodiment may be linked between an operating system (OS) that boots the server and functional elements, and the data area may store data generated as the server is used.

In an embodiment, the database 330 may be any of various storage devices such as a ROM, a RAM, an EPROM, a flash drive, and a hard drive, and may also be a web storage that performs a storage function of the database 330 on the Internet.

The database 330 may be a removable storage medium on the server.

The processor module 310 may control overall operation of each part described above and implement the repeater management service.

For example, the processor module 310 may be a system on chip (SOC) suitable for a server including a central processing unit (CPU) and/or a graphics processing unit (GPU), and may execute, for example, an operating system (OS) and/or application program stored in the database 330 and control each component of the server. However, the disclosure is not limited thereto.

The processor module 310 may communicate with each component internally through a system bus, and may include one or more bus structures (e.g., predetermined or selectable bus structures). For example, the system bus may include a local bus.

The processor module 310 may be implemented by at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical parts for performing functions.

Although the service providing server 300 according to the embodiment of the disclosure performs the functional operation as described above, the disclosure is not limited thereto, and various other embodiments may be possible. For example, at least a part of the functional operation performed by the service providing server 300 may be performed by an external device (e.g., the repeater 200) according to the embodiment. For example, at least a part of a functional operation performed by the external device may be further performed by the service providing server 300.

### Method for Managing Multiple External Repeaters

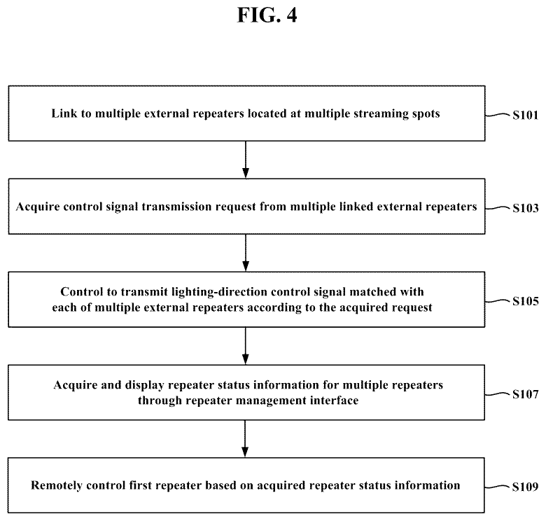

Hereinafter, detailed description of a method for managing multiple external repeaters in at least one processor of the terminal 100 according to an embodiment of the disclosure is provided below in detail with reference to the attached FIGS. 4 to 8.

In a method for managing multiple external repeaters using the terminal 100 (e.g., refer to FIG. 1), at least one processor of the terminal 100 may execute at least one repeater management application 111 (e.g., refer to FIG. 2) stored in at least one memory 110 (e.g., refer to FIG. 2) or the repeater management application 111 may operate in a background state in an embodiment of the disclosure.

Hereinafter, detailed description of the repeater management application 111 that supports the terminal 100 described above performing the method for managing multiple external repeaters by the at least one processor of the terminal 100 operating to execute the instructions of the memory 110 is provided below.

Detailed description of the application 111 performing the method of managing multiple external repeaters described above by the at least one processor of the terminal 100 operating to execute the instructions of the processor assembly 120 is provided below.

FIG. 4 is a schematic flowchart showing the method of managing multiple external repeaters according to an embodiment of the disclosure.

Referring to FIG. 4, in the embodiment, the application 111 (e.g., refer to FIG. 2) may be linked to multiple external repeaters located (or disposed) at multiple streaming spots (S101).

In the embodiment, the streaming spot may be a type of outdoor theater where a number (e.g., a predetermined or selectable number) of people gather to stream (e.g., view) a performance video (hereinafter, streaming video) obtained by filming the performance held in the actual auditorium.

A type of the streaming video may be classified into a real-time video and a recorded video. Hereinafter, detailed description the streaming video that is the real-time video is provided below.

In the embodiment, the repeater 200 (e.g., refer to FIG. 1) that transmits a control signal including data (e.g., the lighting-direction synchronization data) for causing light emitting devices within a radius (e.g., a predetermined or selectable radius) to emit light in the same emission pattern as the emission pattern directed in the actual auditorium may be installed in each streaming spot.

The repeater 200 may receive a control signal (e.g., the lighting-direction control signal) including the lighting-direction synchronization data from the service providing server 300 (hereinafter, server 300) and transmit the control signal. The repeater 200 may receive a streaming video playback signal from the server 300 and/or an external server (e.g., a streaming server) and transmit the streaming video playback signal.

In the embodiment, the repeater 200 may receive both the lighting-direction control signal and the streaming video playback signal and transmit the signals. However, the disclosure is not limited thereto, and the repeater 200 may transmit only the lighting-direction control signal and a separate projector, and the streaming video playback signal may be installed at the streaming spot. The separate projector may receive the streaming video and the streaming video playback signal and transmit the streaming video. The projector may output the streaming video on a screen (e.g., a predetermined or selectable screen) according to the acquired streaming video playback signal.

The repeater 200 and/or the projector located (or disposed) in each of the streaming spots may be installed in connection with the server 300. Accordingly, in the embodiment, the application 111 may be linked to multiple external repeaters and/or projectors electrically connected to the server 300.

Hereinafter, detailed description of targets linked to the server 300 which are the multiple external repeaters 200, and the lighting-direction control signal that is transmitted to the external repeater 200 for the convenience of description is provided below.

In the embodiment, the application 111 may acquire a control signal transmission request from the multiple linked external repeaters (S103).

For example, in the embodiment, the application 111 may acquire the control signal transmission request based on an input (e.g., a predetermined or selectable input) from the streaming spot staff (hereinafter, field staff). The field staff may manage the streaming spot where the multiple linked external repeaters are located (or disposed).

The field staff according to the embodiment may perform the input to the repeater 200 and request to transmit the lighting-direction control signal corresponding to the streaming video played at the streaming spot where the repeater 200 is located (or disposed).

For example, the input may include an input for turning on a power supply of the repeater 200, activating a GPS function, selecting a serial number, name, and the like of the streaming video being played, and pressing a control signal transmission button. The number of people gathered at the streaming spot may also be input. Such an input may be performed directly in the repeater 200, but may also be performed indirectly in the terminal of the field staff linked to the repeater 200.

For example, the application 111 in the embodiment may acquire the control signal transmission request from the multiple linked external repeaters based on the input acquired in the terminal 100 of the field staff and/or the repeater 200.

In the embodiment, the application 111 may control the multiple external repeaters to transmit a control signal including the lighting-direction synchronization data matched with each of the multiple external repeaters according to the acquired request (S105).

For example, in the embodiment, the application 111 may control to transmit a control signal including command data that activates the light emitting devices located (or disposed) within the radius. Thus, the light emitting devices may emit light with the lighting-direction synchronization data matched with each of the multiple external repeaters. The control signal may be transmitted according to the acquired request.

The transmitted control signal (e.g., the lighting-direction control signal) may be the same control signal as a lighting-direction control signal for the actual auditorium.

The lighting-direction control signal for the actual auditorium may include the basic direction data and/or the seat-specific direction data.

The basic direction data may be set based on an emission pattern setting value (e.g., emission time, brightness, color, and effect) of the light emitting device according to a performance configuration. The seat-specific direction data may be data in which the basic direction data is set so that light is emitted differently for each seat. For example, the basic direction data may be set to differently emit light in different seats to form the seat-specific direction data.

In the actual auditorium, the lighting-direction control signal including the seat-specific direction data may be transmitted, and the lighting-direction control signal including the basic direction data may be transmitted to the repeater 200. In another embodiment, the repeater 200 may receive a lighting-direction control signal including seat-specific direction data for an area (e.g., a predetermined or selectable area) that has been randomly determined and transmit the lighting-direction control signal.

However, since the streaming spot that receives and transmits the lighting-direction control signal for the actual auditorium is different from seat layout and/or the number of seats of the actual auditorium, a lighting-direction control signal for a streaming spot may be separately present (or additionally prepared) in another embodiment.

The lighting-direction control signal for a streaming spot that is present separately may be transmitted based on the lighting-direction synchronization data pre-stored in the server 300 differently according to the number of people.

Hereinafter, for the convenience of description, detailed description of the lighting-direction control signal for a streaming spot that is separately present in the server 300, and the control signal transmitted to the repeater 200 according to the acquired request that is the lighting-direction control signal for a streaming spot is provided below.

In the embodiment, the lighting-direction synchronization data transmitted to each external repeater may be identified according to at least one of an artist name, performance name, performance date and time, and/or performance number and may be pre-stored in the server 300.

For example, in the embodiment, the application 111 may extract the lighting-direction synchronization data matched with the acquired request from the pieces of lighting-direction synchronization data pre-stored in the server 300.

Accordingly, in the embodiment, the application 111 may control the multiple external repeaters 200, and the multiple external repeaters 200 may transmit a control signal including the extracted lighting-direction synchronization data.

In the embodiment, the application 111 may acquire and display the repeater status information for multiple repeaters through the repeater management interface (S107).

The repeater management interface according to the embodiment may be a manager interface for managing a performance progress status in the actual auditorium and/or a streaming progress status at the streaming spot where multiple external repeaters electrically connected to the server 300 to transmit a control signal are located (or disposed).

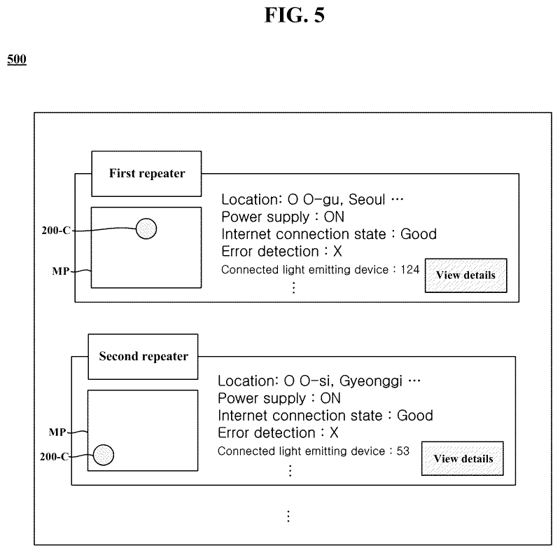

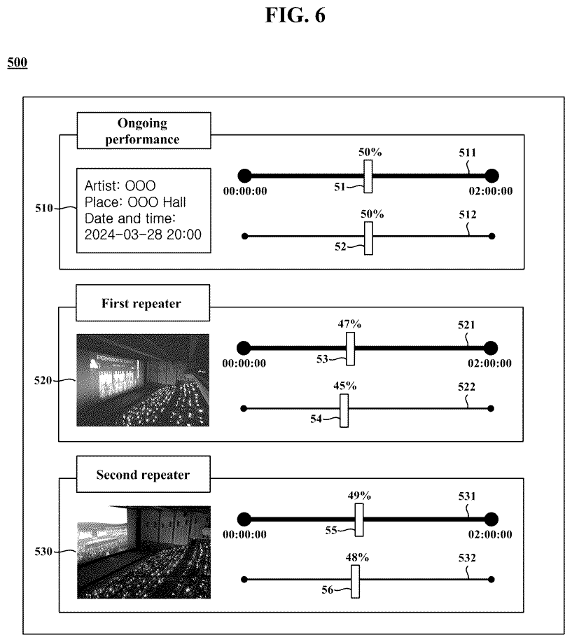

FIGS. 5 and 6 are schematic diagrams of the repeater management interface according to an embodiment of the disclosure.

Referring to FIGS. 5 and 6, in the embodiment, the application 111 (e.g., refer to FIG. 2) may display the repeater status information and/or performance status information through the repeater management interface 500.

In the embodiment, the application 111 may display repeater status information and/or performance status information for each of all external repeaters installed at the streaming spot through the repeater management interface 500.

The repeater status information according to the embodiment may be information indicating whether the repeater 200 may operate normally according to the light lighting-direction control signal.

In the embodiment, the repeater status information may include at least one of the repeater power supply state, the repeater location, the repeater Internet connection state, the repeater operation state, and/or the number of light emission devices electrically connected to the repeater.

For example, the repeater power supply state may be displayed as one of On, Off, Connected, and Disconnected. The repeater Internet connection state may be displayed as “Good”, “Normal”, “Slow”, or the like depending on an Internet connection speed based on a standard (e.g., a preset or selectable standard). The repeater operation state may be displayed as one of Connected, Disconnected, and Error depending on whether or not an error is found in the repeater. When the error is displayed, the number of the repeater may be displayed together. The number of light emitting devices electrically connected to the repeater may be displayed as a number (e.g., a predetermined or selectable number), which is the number of light emitting devices that are normally receiving the control signal of the repeater.

In the embodiment, the repeater location included in the repeater status information may be displayed as repeater location information (MP). In the embodiment, the repeater location information (MP) may mean content roughly indicating the location at which the repeater 200 is disposed at the streaming spot.

For example, the application 111 may display a repeater location 200-C by acquiring the location information of each repeater based on the GPS built into (or disposed in) the repeater.

The performance status information according to the embodiment may be information that visually indicates the performance status at the actual auditorium and a progress streaming progress status at the streaming spot where the repeater 200 is located (or disposed).

In the embodiment, the performance status information may include basic information, progress percentage, and status information of the control signal for the currently ongoing performance, and/or a progress percentage and status information of the control signal for the streaming video provided by each of multiple repeaters 200.

Hereinafter, detailed description of the performance status information included in the repeater status information is provided below.

For example, the application 111 according to the embodiment may display performance status information including basic information 510, a degree of performance progress 511, and an auditorium control signal 512 for the currently ongoing performance through the repeater management interface 500.

In the embodiment, the application 111 may display performance status information including pieces of streaming spot site information 520 and 530, degrees of streaming performance progress 521 and 531, and streaming spot control signals 522 and 532 for each repeater for the streaming performance in progress at multiple spots through the repeater management interface 500.

Although FIG. 6 illustrates only the first repeater and the second relay, the application 111 in the embodiment may display all of the multiple external repeaters electrically connected to the server 300 through the repeater management interface 500.

The basic information 510 may be information on the currently ongoing performance acquired from the server 300, and may include at least one of performance artists, a performance place, and a performance date and time.

The degree of performance progress 511 may be information indicating a time point when the performance is currently held in a running time of the performance. The time point may be indicated as a performance progress time point 51. For example, the performance progress time point 51 may be indicated as a time composed of hours, minutes, and seconds, or indicated as a progress percentage (%) compared to the total running time.

The auditorium control signal 512 may be information indicating a time point when an auditorium control signal is currently transmitted in a running time of a control signal transmitted from the auditorium. The time point may be indicated as an auditorium control signal transmission time point 52.

The performance progress time point 51 and the auditorium control signal transmission time point 52 may be the same. Thus, video and control signals may be transmitted to the outside in the auditorium without delay.

The streaming video progress 521 may be information indicating a time point when the streaming performance is held in a running time of the streaming performance. The time point may be indicated as a streaming time point 53. Similarly, the streaming time point 53 may also be indicated as time and/or percentage.

The performance progress time point 51 and the streaming time point 53 may be different. Thus, a delay may occur depending on a connection state of the terminal 100, the repeater 200, and/or the server 300, and the performance may be a pre-recorded performance rather than a real-time streaming performance.

The streaming spot control signal 522 may be information indicating a time point when the streaming spot control signal is currently transmitted in a running time of a control signal transmitted from the streaming spot. The time may be indicated as a streaming spot control signal transmission time point 54.

The performance progress time point 51 and the streaming time point 53 may be different. Thus, a performance that is being held in real time may be transmitted to the external repeater 200 via the server 300, and therefore a delay may occur depending on an Internet connection state or the like.

Similarly, the streaming time point 53 and the streaming spot control signal transmission time point 54 may also be different. Thus, transmission source sites of the streaming video playback signal and the lighting-direction control signal for the streaming video may be different.

The streaming points in time 53 and 55 and the streaming spot control signal transmission points in time 54 and 56 of the first and second repeaters may also be different depending on Internet connection states of streaming spots where the respective repeaters are located (or disposed).

In the embodiment, the application 111 may display the pieces of streaming spot site information 520 and 530 through the repeater management interface 500.

The first streaming spot site information 520 for the first repeater and the second streaming spot site information 530 for the second repeater may be images and/or videos obtained by filming respective streaming spots through cameras included in the respective repeaters.

The pieces of the first and second streaming spot site information 520 and 530 may include streaming videos played in the respective streaming spots and/or emission direction scenes of the light emitting devices. Thus, the manager may ascertain (or determine) on-site situations of the respective streaming spots.

In the embodiment, the application 111 may remotely control the first repeater based on the acquired repeater status information (S109).

For example, in the embodiment, the application 111 may remotely control the first repeater and minimize a time difference between the actual performance and the streaming performance ascertained from the acquired repeater status information.

For example, in the embodiment, the application 111 may perform remote control for at least one of 1) a power supply for the repeater, 2) the Internet connection state of the repeater, and 3) a streaming video and streaming control signal synchronization.

In the embodiment, the application 111 may remotely control a power supply of the first repeater, and the power supply of the first repeater may be turned On and/or Off based on repeater status information of the first repeater.

For example, when the manager determines that an error has occurred in the first repeater based on the repeater status information of the first repeater, the manager may remotely control the power supply of the first repeater. Thus, the power supply of the first repeater may be rebooted.

In the embodiment, the application 111 may remotely control an Internet connection between the first repeater and the server 300 based on the repeater status information of the first repeater.

In the embodiment, the application 111 may detect at least one external repeater in which a temporal error occurs between the actual performance time point and the streaming video time point and/or between the streaming video and the streaming spot control signal based on the repeater status information.

In the embodiment, the application 111 may remotely control each repeater and synchronize between the performance time point and the streaming video time point and/or between the streaming video and the streaming spot control signal for the detected external repeater. For example, the application 111 may remotely control the repeaters and synchronize the performance time point and the stream video time point and/or synchronize the stream video and the streaming spot control signal for the detected external repeater.

When the streaming video is a pre-recorded video, synchronization between the performance time point and the streaming video time point may be unnecessary. Even when the streaming video is a real-time video, the application 111 may minimize a temporal error between the two videos by rechecking the Internet connection state and performing re-synchronization.

However, the synchronization between the streaming video and the streaming spot control signal should be necessarily made regardless of whether the streaming video is the real-time video or the pre-recorded video. For example, the synchronization between the streaming video and the streaming spot control signal may be made in both of the streaming videos of the real-time video and the pre-recorded video.

Therefore, in the embodiment, the application 111 may perform a synchronization process between the streaming video and the streaming spot control signal based on the repeater status information.

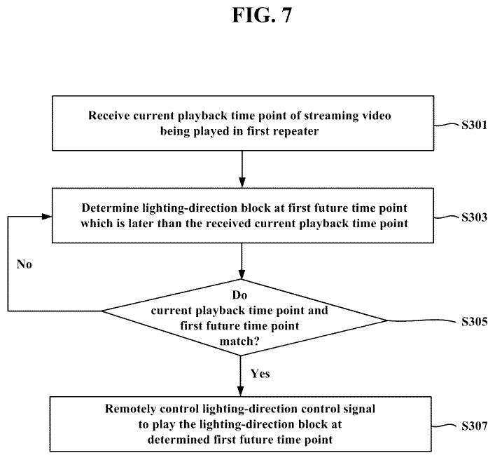

FIG. 7 is a schematic flowchart illustrating a synchronization process between the streaming video and the streaming spot control signal according to an embodiment of the disclosure.

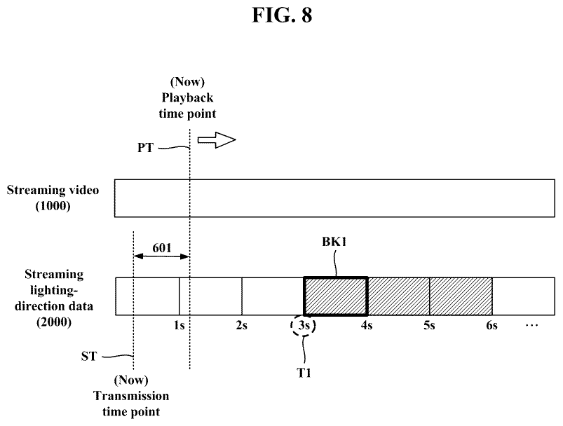

FIG. 8 is a schematic diagram illustrating a synchronization process according to an embodiment of the disclosure.

Referring to FIGS. 7 and 8, in the embodiment, the application 111 (e.g., refer to FIG. 2) may receive the current playback time point of the streaming video being played in the first repeater (S301).

A current playback time PT of a streaming video 1000 illustrated in FIG. 8 may be changed in real time over time. For example, the current playback time PT may move in an illustrated direction indicated by an arrow over time.

In the first repeater, a streaming lighting-direction control signal matched with the streaming video 1000 being played may be being transmitted. FIG. 8 illustrates streaming light emission data 2000 included in the streaming lighting-direction control signal.

The streaming lighting-direction control signal being transmitted may be transmitting a transmission signal at a time point that is time (e.g., predetermined or selectable time) earlier or later than the current playback time PT of the streaming video 1000. For example, the application 111 may be transmitting a transmission signal at a current transmission time point ST that is a first time 601 earlier than the current playback time point PT.

The current transmission time point ST may also be changed in real time over time.

However, a time interval of the first time 601 may be disposed between the current playback time point of the streaming video 1000 that changes in real time and the current transmission time point according to the streaming lighting-direction data 2000.

In the embodiment, the application 111 may determine a lighting-direction block at a first future time point T1 that is a future time point than the received current playback time PT (S303).

The lighting-direction block according to the embodiment may be a section included in the streaming lighting-direction data 2000. An emission pattern may be directed for each unit time in the section.

In the embodiment, the application 111 may preset a minimum time between the current playback time PT and the first future time point T1. When the first future time point T1 is within the minimum time from the current playback time point PT, the synchronization process may be highly likely not to be completed before the first future time point T1 arrives. For example, the synchronization process may not be completed before the first future time point T1, when the first future time point T1 is within the minimum time from the current playback time point PT.

For example, in the embodiment, the application 111 may determine a first lighting-direction block BK1 located (or disposed) at the first future time point T1 at least the minimum time later from the current playback time. For example, the application 111 may determine the first lighting-direction block BK1 disposed at the first future time point T1, and the first future time point T1 may be greater than the minimum time.

After the first lighting-direction block BK1 at the first future time point T1 is determined, the current playback time PT may proceed in a direction indicated by an arrow and be changed.

In the embodiment, the application 111 may determine whether the current playback time PT and the first future time point T1 match (S305).

When the current playback time PT and the first future time point T1 do not match (e.g., when the first future time point T1 is earlier than the current playback time point PT), the application 111 in the embodiment may return to step S303 and re-determine the lighting-direction block at the first future time point.

For example, when the current playback time PT and the first future time point T1 match, the application 111 in the embodiment may remotely control the lighting-direction control signal. Thus, the first lighting-direction block BK1 at the first future time point T1 may be played (S307).

The application 111 in the embodiment may remotely control to play the first lighting-direction block BK1 at the moment when the current playback time PT matches the first future time point T1.

Thus, in the embodiment, the application 111 may minimize a temporal error by synchronizing the streaming video to the streaming lighting-direction control signal at the streaming spot. For example, the application 111 may synchronize the video to the streaming lighting-direction control signal at the streaming spot, and the temporal error may be minimized.

In the embodiment, the application 111 may recommend optimized repeater setting information based on the repeater status information.

In the embodiment, the application 111 may acquire repeater location information based on the GPS of the repeater.

In the embodiment, the application 111 may remotely control the repeater, and the repeater may transmit a test signal at the location based on the acquired repeater location information.

The test signal may be transmitted multiple times with a differentially set signal radius and propagation direction.

The signal radius may be a range at which the control signal reaches. The propagation direction may be a propagation direction of a directional antenna having the property at which the intensity of electromagnetic waves changes depending on a direction.

The test signal may have a different signal radius and signal sensitivity for each propagation direction depending on a disposition location of the repeater, obstacles near the repeater, or the like.

In the embodiment, the application 111 may determine a first signal radius and a first propagation direction with the best signal sensitivity according to a test signal transmission result.

Accordingly, in the embodiment, the application 111 may recommend optimized repeater setting information including the determined first signal radius and first propagation direction.

In the embodiment, the application 111 may set the recommended optimized repeater setting information in an external repeater located (or disposed) at the streaming spot.

In the embodiment, the application 111 may determine the optimized repeater setting information in the repeater location information based on the test signal transmission result.

It is possible to improve the efficiency of repeater management by recommending and determining such optimized repeater setting information, and a repeater management service staff may remotely set a value most appropriate for the repeater location without visiting the streaming spot. For example, the repeater may be remotely recommended and determined by the optimized repeater setting information.

With the method and system for managing multiple external repeaters according to an embodiment of the disclosure, the multiple external repeaters may be remotely controlled, and the multiple external repeaters may transmit a control signal for causing multiple light emitting devices located (or disposed) at a stream spot (e.g., a predetermined or selectable streaming spot), which is a separate place from an actual auditorium. Thus, the multiple light emitting devices may emit light in the same emission pattern as an emission pattern directed at an actual auditorium, and perform the same direction as at the actual auditorium while streaming a real-time performance at the external auditorium. Therefore, an experience similar to attending the actual performance may be provided and audience satisfaction may be increased.

With the method and system for managing multiple external repeaters according to the embodiment, a status of multiple repeaters installed at streaming spots (e.g., predetermined or selectable streaming spots), which are separate places from an actual auditorium, may be checked in real time and the multiple repeaters may be remotely controlled. Thus, immediate and flexible response may be enabled even when an error occurs in an external repeater. Also, time, human, and economic losses required to resolve a problem may be minimized when the problem occurs.

The method and system for managing multiple external repeaters according to an aspect of the disclosure may allow a staff of a streaming spot (e.g., a predetermined or selectable streaming spot), which is a separate place from an actual auditorium, to install repeaters on his/her own without dispatching an operator to the streaming spot, which is the separate place from the actual auditorium. For example, the multiple external repeaters may be installed by various places without the instruction of the operator. Thus, the number of operators dispatched to the streaming spot, which is the separate place from the actual auditorium, may be decreased before, during, and after the performance, and labor costs may be decreased.

However, the effects of the disclosure are not limited to the effects mentioned above, and other effects not mentioned may be clearly understood from the detailed description.

The embodiment of the disclosure described above may be implemented in the form of program instructions that may be executed through various computer components and recorded on a computer-readable recording medium. The computer-readable recording medium may include program instructions, data files, data structures, and the like alone or in combination thereof. The program instructions recorded on the computer-readable recording medium may be program instructions specially designed and configured for the disclosure or various program instructions and available to those skilled in the art of computer software. Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory. Examples of the program instruction include not only machine language codes such as codes generated by a compiler, but also high-level language codes that can be executed by a computer using an interpreter, or the like. The hardware device may be changed into one or more software modules to perform the processing according to the disclosure, and vice versa.

The specific executions described herein are exemplary and do not limit the scope of the disclosure in any way. For the sake of brevity of the specification, description of conventional electronic components, control systems, software, and other functional aspects of the systems may be omitted. Further, connections or connection members between the components illustrated in the drawings are merely examples of functional connections and/or physical or circuit connections, and may be indicated as various functional connections, physical connections, or circuit connections that are replaceable or additional ones in an actual device. Further, when there is no specific mention such as “essential” and “important,” a corresponding component may not be required for the application of the disclosure.

The above description is an example of technical features of the disclosure, and those skilled in the art to which the disclosure pertains will be able to make various modifications and variations. Thus, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A method for managing multiple external repeaters in a repeater management application of a terminal, the method comprising:
linking to the multiple external repeaters, which are electrically connected to a service providing server and located at multiple streaming spots;
acquiring a request to transmit a lighting-direction control signal from each of the linked multiple external repeaters;
controlling to transmit the lighting-direction control signal matched with each of the multiple external repeaters according to the acquired request;
acquiring and displaying repeater status information for the multiple external repeaters through a repeater management interface; and
determining a first repeater of the multiple external repeaters based on the acquired repeater status information and remotely controlling the first repeater.

2. The method for managing multiple external repeaters of claim 1, wherein the linking to the multiple external repeaters includes:
acquiring a streaming video from the service providing server; and
at least one of controlling the first repeater placed in a first streaming spot of the multiple streaming spots to transmit a playback signal of the acquired streaming video; and
controlling the first repeater placed in the first streaming spot to acquire the playback signal of the streaming video transmitted from an external terminal or server placed in the first streaming spot.

3. The method for managing multiple external repeaters of claim 2, wherein the acquiring of the request to transmit the lighting-direction control signal includes:
detecting a first streaming video being played by the first repeater requesting to transmit the lighting-direction control signal; and
extracting first lighting-direction synchronization data matched with the detected first streaming video.

4. The method for managing multiple external repeaters of claim 3, wherein the extracting of the first lighting-direction synchronization data includes:
determining that a type of the first streaming video is one of a real-time video and a recorded video; and
extracting at least one of the first lighting-direction synchronization data being transmitted in real time from an actual auditorium and second lighting-direction synchronization data pre-stored in the service providing server according to the determined video type.

5. The method for managing multiple external repeaters of claim 4, wherein the controlling of transmitting the lighting-direction control signal includes:
determining at least one of basic direction data and seat-specific direction data, the basic direction data being generated by setting at least one of emission time, brightness, color, and effect of the light emitting devices within a predetermined radius by default according to a performance configuration, the seat-specific direction data being generated by setting the at least one of emission time, brightness, color, and effect of the light emitting devices within a predetermined radius of the basic direction data differently for each seat; and
controlling to transmit the lighting-direction control signal including command data that activates light emission in accordance with the determined direction data.

6. The method for managing multiple external repeaters of claim 1, wherein the acquiring and displaying of the repeater status information through the repeater management interface includes:
acquiring and displaying the repeater status information including at least one of a repeater power supply state, a repeater location, a repeater Internet connection state, a repeater operation state, and the number of light emitting devices electrically connected to the repeater.

7. The method for managing multiple external repeaters of claim 1, wherein the acquiring and displaying of the repeater status information through the repeater management interface includes:
displaying a degree of progress of a performance being held at an actual auditorium and a lighting-direction control signal being transmitted in the performance, and a degree of progress of a streaming performance being transmitted from each of the multiple repeaters and a lighting-direction control signal being transmitted in the streaming performance.

8. The method for managing multiple external repeaters of claim 1, wherein the determining and remotely controlling the first repeater based on the acquired the repeater status information includes:
determining the first repeater whose streaming time point deviates from a performance progress time point by more than a tolerance range; and
remotely controlling at least one of a power supply, an Internet connection state, and synchronization between a video and a control signal for the determined first repeater.

9. The method for managing multiple external repeaters of claim 1, wherein the remotely controlling of the synchronization between the video and the control signal includes:
receiving a current playback time point of the streaming video played by the first repeater;
determining a lighting-direction block at a first future time point which is later than the received current playback time point;
determining whether the current playback time point and the first future time point match; and
remotely controlling the lighting-direction control signal to play the lighting-direction block at the determined first future time point when the current playback time point and the first future time point match.

10. A system for managing multiple external repeaters linked to a service providing server and the multiple external repeaters electrically connected the service providing server, wherein at least one application stored in a memory of a terminal, which includes at least one memory and at least one processor, and executed by the processor to provide a repeater management service, the at least one application performs:
acquiring a request to transmit a lighting-direction control signal from each of the multiple external repeaters;
controlling to transmit the lighting-direction control signal matched with each of the multiple external repeaters according to the acquired request;
acquiring and displaying repeater status information for the multiple external repeaters through a repeater management interface; and
determining a first repeater of the multiple external repeaters based on the acquired repeater status information and remotely controlling the first repeater.
